(19) United States
(12) Patent Application Publication
(10) Pub. No.: US 2015/0017441 A1
(43) Pub. Date: Jan. 15, 2015

(54) ELASTOMER COMPOSITION, AND INSULATED WIRE AND INSULATED CABLE USING THE SAME

(71) Applicant: Hitachi Metals, Ltd., Tokyo (JP)

(72) Inventors: Atsuro YAGUCHI, Hitachi (JP); Ryutaro KIKUCHI, Hitachi (JP)

(21) Appl. No.: 14/319,295

(22) Filed: Jun. 30, 2014

(30) Foreign Application Priority Data
Jul. 9, 2013 (JP) 2013-143881

(51) Int. Cl. H01B 3/44; H01B 3/02; C08L 23/06; C08K 5/20; C08K 3/34; C08L 23/08

(52) U.S. Cl. CPC H01B 3/441; C08K 3/34; C08L 23/0807; C08L 23/06; C08K 5/20; H01B 3/02; C08L 2205/02; C08L 2203/202; C08L 2207/066
USPC 428/383; 524/451; 524/210; 428/390

(57) ABSTRACT

An elastomer composition includes a base polymer including not less than 50 mass % of ethylene-α-olefin copolymer, and a talc that has a mass ratio of silicon to magnesium (Si/Mg) of 0.9 to 1.8 and is mixed in an amount of 100 to 250 parts by mass per 100 parts by mass of the ethylene-α-olefin copolymer.

The present application is based on Japanese patent application No. 2013-143881 filed on Jul. 9, 2013, the entire contents of which are incorporated herein by reference.

### BACKGROUND OF THE INVENTION

1. Field of the Invention

The invention relates to an elastomer composition and an insulated wire and an insulated cable using the elastomer composition. In more detail, the invention relates to an elastomer composition suitable especially for EP rubber insulated chloroprene rubber sheathed cabtyre cable (PNCT), and an insulated wire and an insulated cable using the elastomer composition.

2. Description of the Related Art

Ethylene-propylene rubber (EP rubber) has high volume resistivity and is thus used as an insulating coating material for electric wires and cables. It is used for, e.g., EP rubber insulated chloroprene rubber sheathed cabtyre cable (PNCT), etc. When EP rubber is used for an insulation layer material, a filler is also included in such an insulation layer material in addition to an EP rubber, a cross-linking agent and an age inhibitor, etc. As the filler, it is possible to use, e.g., clay, talc and calcium carbonate, etc., and it is preferable to use talc from the viewpoint of flexibility and electrical insulation, etc. (see, e.g., JP-A-2008-150557).

PNCT is manufactured, for example, roughly by a step of covering a core wire (conductor) with an insulation layer, a step of twisting insulated wires together and a step of providing a sheath covering. In the step of providing a sheath covering, a sheath material is extruded by an extruder so as to cover the twisted insulated wires and is cross-linked by applying high-pressure steam of about 10 to 20 kg/cm². At this time, the insulation layer at twisted portions may be crushed due to the high-pressure steam, resulting in defects. To solve this problem, a method of controlling the type or crosslinking degree of EP rubber and a method of suppressing crushing by increasing an amount of talc as a filler are known (see, e.g., non-patent literature “Rubber Industry Handbook, fourth edition”).

### SUMMARY OF THE INVENTION

Increasing the amount of talc mixed in a composition constituting the insulation layer may cause a decrease in insulation resistance, poor appearance and decreases in flexibility and aging properties etc. Therefore, the cable or wire may fail to meet the standards.

It is an object of the invention to provide an elastomer composition that exhibits excellent resistance to crushing, insulation resistance and outer appearance when molded into e.g. an insulation layer/sheath of an insulated wire/insulated cable even if a large amount of talc is added, as well as an insulated wire and an insulated cable each using the elastomer composition.

As a result of intense study to achieve such an object, the present inventors found that talcs used for a composition of insulation layer are composed of different components depending on locality and include e.g. magnesium oxide, silica, iron oxide, calcium oxide or aluminum oxide etc. as impurities and, when the amount of talc in a composition constituting insulation layers is increased, impurities, especially magnesium oxide and silica, have an impact and cause problems of a decrease in insulation resistance, poor appearance or a decrease in flexibility or aging properties etc. depending on the mass ratio of silicon to magnesium (Si/Mg) in the talc, and the invention was thereby completed. That is, the invention provides an elastomer composition described below and an insulated wire and an insulated cable which use such an elastomer composition.

(1) According to one embodiment of the invention, an elastomer composition comprises:

a base polymer including not less than 50 mass % of ethylene-α-olefin copolymer; and

a talc that has a mass ratio of silicon to magnesium (Si/Mg) of 0.9 to 1.8 and is mixed in an amount of 100 to 250 parts by mass per 100 parts by mass of the ethylene-α-olefin copolymer.

In the above embodiment (1) of the invention, the following modifications and changes can be made.

(i) The elastomer composition further comprises:

an amide-based lubricant mixed in an amount of 0.1 to 2 parts by mass per 100 parts by mass of the ethylene-α-olefin copolymer; and

a thiuram-based vulcanization retarder mixed in an amount of 0.1 to 1 part by mass per 100 parts by mass of the ethylene-α-olefin copolymer,

wherein the mixed amount in total of the amide-based lubricant and the thiuram-based vulcanization retarder is not more than 2 parts by mass per 100 parts by mass of the ethylene-α-olefin copolymer.

(2) According to another embodiment of the invention, an insulated wire comprises:

a conductor; and

an insulation layer covering an outer periphery of the conductor,

wherein the insulation layer comprises the elastomer composition according to the above embodiment (1) and being crosslinked.

(3) According to another embodiment of the invention, an insulated cable comprises:

at least one insulated wire comprising a conductor and an insulation layer; and

a sheath covering an outer periphery of the at least one insulated wire,

wherein the sheath comprises the elastomer composition according to the above embodiment (1) and being crosslinked.

### Effects of the Invention

According to one embodiment of the invention, an elastomer composition can be provided that exhibits excellent resistance to crushing, insulation resistance and outer appearance when molded into e.g. an insulation layer/sheath of an insulated wire/insulated cable even if a large amount of talc is added, as well as an insulated wire and an insulated cable each using the elastomer composition.

### BRIEF DESCRIPTION OF THE DRAWINGS

Next, the present invention will be explained in more detail in conjunction with appended drawings, wherein:

FIG. 1 is a schematic cross sectional view showing an insulated cable in an embodiment of the present invention (an insulated cable provided with one or more insulated wires, each composed of a conductor and an insulation layer, and a sheath formed by providing a predetermined elastomer composition so as to cover an outer peripheral side of the one or more insulated wires and then crosslinking the elastomer composition); and

FIG. 2 is a schematic cross sectional view showing an insulated wire in the embodiment of the invention (an insulated wire provided with a conductor and an insulation layer formed by providing a predetermined elastomer composition so as to cover an outer periphery of the conductor and then crosslinking the elastomer composition).

### DETAILED DESCRIPTION OF THE PREFERRED EMBODIMENT

### Summary of Embodiment

An elastomer composition in the present embodiment includes a base polymer including not less than 50 mass % of ethylene-α-olefin copolymer; and a talc which has a mass ratio of silicon to magnesium (Si/Mg) of 0.9 to 1.8 and is mixed in an amount of 100 to 250 parts by mass per 100 parts by mass of the ethylene-α-olefin copolymer.

An insulated wire in the present embodiment is provided with a conductor and an insulation layer formed by providing the above-mentioned elastomer composition so as to cover an outer periphery of the conductor and then crosslinking the elastomer composition.

Furthermore, an insulated cable in the present embodiment is provided with one or more insulated wires, each composed of a conductor and an insulation layer, and a sheath formed by providing the above-mentioned elastomer composition so as to cover an outer peripheral side of the one or more insulated wires and then crosslinking the elastomer composition.

### Embodiment

An embodiment of an elastomer composition of the invention and an insulated wire and an insulated cable using the same will be specifically described below in reference to the drawings.

I. Elastomer Composition

The elastomer composition in the present embodiment includes a base polymer including not less than 50 mass % of ethylene-α-olefin copolymer; and a talc which has a mass ratio of silicon to magnesium (Si/Mg) of 0.9 to 1.8 and is mixed in an amount of 100 to 250 parts by mass per 100 parts by mass of the ethylene-α-olefin copolymer. Each component will be specifically described below.

1. Base Polymer

(1-1) Ethylene-α-olefin Copolymer

The base polymer used for the elastomer composition in the present embodiment includes not less than 50 mass %, exemplarily not less than 80 mass %, of ethylene-α-olefin copolymer.

In the present embodiment, the amount of the ethylene-α-olefin copolymer mixed in the base polymer needs to be not less than 50 mass % of the base polymer as mentioned above from the viewpoint of elongation. Elongation decreases when less than 50 mass %.

The ethylene-α-olefin copolymer in the present embodiment exemplarily has a Mooney viscosity at 125° C. of 10 to 60. When outside of this range, mechanical characteristics (elongation) may decrease.

Examples of α-olefin constituting the ethylene-α-olefin copolymer in the present embodiment include propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene, etc. Of those, propylene is exemplary from the viewpoint of flexibility.

It should be noted that, an amount of the ethylene component (ethylene content) in the ethylene-α-olefin copolymer in the present embodiment is exemplarily 60 to 75 mass % from the viewpoint of mechanical strength.

The ethylene-α-olefin copolymer may include a third copolymer component (third component). Examples of such a third component include ethylidene-norbornene and dicyclopentadiene, etc. The amount of these components in the ethylene-α-olefin copolymer is exemplarily 4 mass % to 6 mass %.

(1-2) Other Polymer Components

Polymer components, other than the ethylene-α-olefin copolymer, constituting the base polymer used in the present embodiment can be, e.g., at least one selected from the group consisting of polyethylene (low-density polyethylene (LDPE), linear low-density polyethylene (LLDPE), linear very low-density polyethylene (VLDPE)), ethylene-methyl methacrylate copolymer (EMMA), ethylene-ethyl methacrylate copolymer (EEMA), ethylene vinyl acetate copolymer (EVA), ethylene-styrene copolymer, maleic anhydride modified ethylene-α-olefin-based copolymer and maleic acid grafted linear low density polyethylene. The amount of these components mixed in the base polymer is exemplarily 0 mass % to 50 mass %.

2. Talc

The talc (3MgO.4SiO₂.H₂O) used for the elastomer composition in the present embodiment has a mass ratio of silicon to magnesium (Si/Mg) of 0.9 to 1.8 and is mixed in an amount of 100 to 250 parts by mass per 100 parts by mass of the ethylene-α-olefin copolymer.

The talc used for the elastomer composition in the present embodiment is mixed in an amount of 100 to 250 parts by mass, exemplarily 100 to 200 parts by mass, per 100 parts by mass of the ethylene-α-olefin copolymer. Resistance to deformation is not sufficient when less than 100 parts by mass while elongation decreases when more than 250 parts by mass.

In the talc used for the elastomer composition in the present embodiment, a mass ratio of silicon to magnesium (Si/Mg) needs to be 0.9 to 1.8, exemplarily 1.0 to 1.6. The chemical formula of the talc is 3MgO.4SiO₂.H₂O as mentioned above and a mass ratio of silicon to magnesium (Si/Mg) in the talc is 1.54 in theory. However, this value varies depending on the amounts of magnesium oxide and silica. As a result of developing insulation layer materials by using a wide variety of talcs in, e.g., EP rubber insulation layer composition for PNCT, the present inventors found that the main factor affecting various characteristics is a mass ratio of silicon to magnesium (Si/Mg) in the talc.

When the mass ratio of silicon to magnesium (Si/Mg) in the talc is less than 0.9 (when the amount of magnesium oxide is excessive), electrical characteristics decrease due to moisture absorption by magnesium oxide. On the other hand, when the mass ratio (Si/Mg) is more than 1.8 (when the amount of silica is excessive), appearance becomes poor presumably due to premature crosslinking even though the particular cause has not been identified.

3. Amide-Based Lubricant and Thiuram-Based Vulcanization Retarder

In addition to the base polymer and the talc described above, an amide-based lubricant and a thiuram-based vulcanization retarder may be mixed to the elastomer composition in the present embodiment, if necessary.

(3-1) Amide-Based Lubricant

The amide-based lubricant is exemplarily mixed in an amount of 0.1 to 2 parts by mass per 100 parts by mass of the ethylene-α-olefin copolymer for the purpose of preventing deterioration in appearance associated with an increase in the amount of silica. A lubricating effect may not be obtained when less than 0.1 parts by mass while electrical characteristics or mechanical strength may decrease when more than 2 parts by mass.

(3-2) Thiuram-Based Vulcanization Retarder

The thiuram-based vulcanization retarder is exemplarily mixed in an amount of 0.1 to 1 part by mass per 100 parts by mass of the ethylene-α-olefin copolymer to prevent deterioration in appearance caused by premature crosslinking. A retarding effect may not be obtained when less than 0.1 parts by mass while sufficient mechanical strength may not be obtained when more than 1 part by mass.

The total amount of the amide-based lubricant and the thiuram-based vulcanization retarder is exemplarily not more than 2 parts by mass per 100 parts by mass of the ethylene-α-olefin copolymer. Sufficient mechanical strength may not be obtained when more than 2 parts by mass.

4. Other Components to be Mixed

To the elastomer composition in the present embodiments, it is possible, if necessary, to mix various components such as cross-linking agents, crosslinking aids, stabilizers, antioxidants, lubricants, crosslinking promoters, plasticizers and vulcanization retarders, in addition to the base polymer, ethylene-α-olefin copolymer, amide-based lubricant and the thiuram-based vulcanization retarder. For example, if necessary, an insulation enhancer such as baked clay may be used, or, another type of vulcanization retarder may be used as long as it has a capability equivalent to thiuram base.

II. Insulated Wire

As shown in FIG. 2, the insulated wire in the present embodiment is composed of a conductor 1 formed of, e.g., a widely-used copper twisted wire and an insulation layer 2 formed by providing the above-mentioned elastomer composition so as to cover an outer periphery of the conductor 1 and then crosslinking the elastomer composition.

III. Insulated Cable

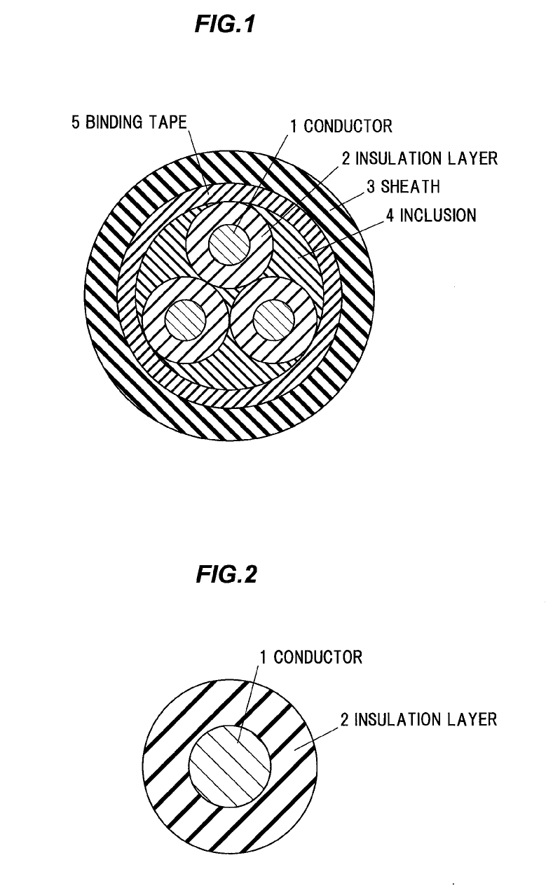

As shown in FIG. 1, the insulated cable in the present embodiment is composed of one or more insulated wires each composed of the conductor 1 and the insulation layer 2, a holding member, e.g., a binding tape 5, which is wound together with, e.g., a paper inclusion 4 on an outer peripheral side of the one or more insulated wires, and a sheath 3 formed by providing the above-mentioned elastomer composition so as to cover an outer periphery of the binding tape 5 and then crosslinking the elastomer composition. In this case, it is exemplary that the insulation layer 2 be formed of the above-mentioned elastomer composition.

### EXAMPLES

The elastomer composition of the invention and the insulated wire and the insulated cable using the same will be described more specifically below in reference to Examples. It should be noted that the following Examples are not intended to limit the invention in any way.

### Example 1

### Components to be Mixed

The following components were mixed. The mixed amounts thereof were as described below (see Table 1).
100 parts by mass of ethylene-α-olefin copolymer (ethylene-propylene copolymer) (Mooney viscosity (125° C., ML₁₊₄):23, ethylene content: 67 mass %, the third component: ethylidene-norbornene, the amount of the third component: 5.8 mass %) as a base polymer component
100 parts by mass of talc (mass ratio (Si/Mg): 0.9) as a talc component
2 parts by mass of peroxide (dicumyl peroxide) as a cross-linking agent
1 part by mass of triallylisocyanurate as a crosslinking aid
5 parts by mass of zinc oxide as a stabilizer
0.3 parts by mass of poly(2,2,4-trimethyl-1,2-dihydroquinoline) as an antioxidant
1.5 parts by mass of poly(mercaptobenzimidazole) as an antioxidant
5 parts by mass of paraffin oil as a softener
1 part by mass of stearic acid as a lubricant
0.5 parts by mass of bisoleic amide as a lubricant
0.5 parts by mass of tetrakis(2-ethylhexyl) thiuram disulfide as a crosslinking promoter

Manufacture of Rubber Compound

The components listed above, except the cross-linking agent, were kneaded at a revolution of 60 rpm using a mixer, thereby making a rubber compound. At this time, temperature at the time of introducing materials was set to 80° C. After introducing the materials, the temperature was increased to 180° C. at a rate of 5° C./min. Once the temperature reached 180° C., the rubber compound was dropped from the mixer and was collected. This compound was extruded into strands using a single screw extruder and was pelletized by cutting the strands after cooling by water. The pellets were introduced together with a cross-linking agent into a stirrer so as to be impregnated with the cross-linking agent, thereby obtaining the final rubber compound.

Manufacture of Insulated Wire

An insulation layer was provided using a 115-mm extruder (length to diameter ratio: L/D=2.0) so as to cover a core wire (conductor). The core wire had a cross sectional area of 0.75 sq and the compound was extruded so that the core wire is covered with a 0.8 mm-thick insulation layer. The core wire with the insulation layer was passed through a steam tubing (at a vapor pressure of 15 kg/cm²) for cross-linking, thereby making an insulated wire.

Manufacture of Insulated Cable

A chloroprene rubber composition was extruded as a sheath (1.7 mm in thickness) on a core composed of two twisted insulated wires using a 115-mm extruder (length to diameter ratio: L/D=2.0) maintained at 70° C. and the core with the sheath was passed through a steam tubing (at a vapor pressure of 15 kg/cm²) for cross-linking, thereby making an insulated cable.

Table 1 shows the mixed components of the elastomer composition used in Example 1 and also shows below-described evaluation results of insulated wires.

### Examples 2 to 23

Samples in Examples 2 to 23 were made in the same manner as Example 1 except that the amounts of the components mixed in the elastomer composition were changed to those shown in Table 1. The evaluation results of the wires are shown in Table 1.

### Comparative Examples 1 to 10

Samples in Comparative Examples 1 to 10 were made in the same manner as Example 1 except that the amounts of the components mixed in the elastomer composition were changed to those shown in Table 2. The evaluation results of the wires are shown in Table 2.

Evaluation Method of Wire

The wires were evaluated by conducting the evaluation tests described below.

(1) Appearance after Extrusion

The outer appearance of the obtained insulated wires was visually checked. The wires having good appearance were regarded as “◯ (passed the test)” and those having rough appearance such as rough surface was regarded as “X (failed the test)”.

(2) Initial Tension

A tubular test piece pulled out of the conductor was subjected to a tensile test in accordance with JIS C 3327. Breaking strength=TS (MPa) and breaking elongation=TE (%) were measured. TS of not less than 4 MPa and TE of not less than 300% are regarded as “◯ (passed)” and others are regarded as “X (failed)”.

(3) Tension after Heat Aging

The test was conducted in accordance with JIS C 3327. After aging a tensile test sample at 100° C. for 96 hours, a tensile test was conducted in the same manner as described above. TS retention (%) after aging and TE retention (%) after aging were evaluated. TS retention of not less than 80% and TE retention of not less than 80% are regarded as “◯ (passed)” and others are regarded as “X (failed)”.

(4) Insulation Resistance

Insulation resistance of the obtained insulated wires was measured in accordance with JIS C 3327. The wires having an insulation resistance value of not less than 500 MΩ·km were regarded as “◯ (passed)” and others are regarded as “X (failed)”.

(5) Resistance to Deformation

Resistance to deformation was evaluated based on the thickness of the insulation layer at twisted portions of the insulated wire as a core in the insulated cable after providing the sheath. In conformity with JIS C 3327, not less than 0.64 mm in thickness is regarded as “◯ (passed)” and others are regarded as “X (failed)”.

As understood from Table 1, Examples 1 to 12 (within the talc composition range of the invention) passed all evaluation tests and satisfied all characteristics.

Examples 13 to 23 (within the talc composition range of the invention, and with various amounts of the amide-based lubricant and the thiuram-based vulcanization retarder) also passed all evaluation tests and satisfied all characteristics.

Comparative Example 1 (the mixed amount of talc is less than 100 parts by mass) is insufficient in crushing resistance and failed the test for insulation layer thickness of the obtained cable.

Comparative Example 2 (the mixed amount of talc is more than 250 parts by mass) failed the test for initial elongation.

Comparative Examples 3 and 4 (talc having a mass ratio (Si/Mg) of 0.8 was used) failed the test for insulation resistance. It is considered that this is caused by high moisture-absorption of magnesium oxide.

Comparative Examples 5 to 10 (talc having a mass ratio (Si/Mg) of 2.0 was used) failed the test for appearance. It is considered that this is due to the large amount of silica and the resulting premature crosslinking. In addition, outer appearance was not improved even in case that the amounts of lubricant and the vulcanization retarder were increased.

TABLE 1

| Mixed components | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Ethylene-propylene | 100 | 100 | 100 | 100 | 100 | 100 | 100 | 100 | 100 | 100 |
| copolymer ⁽¹⁾ | | | | | | | | | | |
| Low-density | 0 | 0 | 0 | 0 | 0 | 0 | 0 | 0 | 0 | 0 |
| polyethylene ⁽²⁾ | | | | | | | | | | |
| Talc 1 ⁽³⁾ | 100 | 250 | 0 | 0 | 0 | 0 | 0 | 0 | 0 | 0 |
| Talc 2 ⁽⁴⁾ | 0 | 0 | 100 | 250 | 0 | 0 | 0 | 0 | 0 | 0 |
| Talc 3 ⁽⁵⁾ | 0 | 0 | 0 | 0 | 100 | 250 | 0 | 0 | 0 | 0 |
| Talc 4 ⁽⁶⁾ | 0 | 0 | 0 | 0 | 0 | 0 | 100 | 250 | 0 | 0 |
| Talc 5 ⁽⁷⁾ | 0 | 0 | 0 | 0 | 0 | 0 | 0 | 0 | 100 | 250 |
| Talc 6 ⁽⁸⁾ | 0 | 0 | 0 | 0 | 0 | 0 | 0 | 0 | 0 | 0 |
| Talc 7 ⁽⁹⁾ | 0 | 0 | 0 | 0 | 0 | 0 | 0 | 0 | 0 | 0 |
| Talc 8 ⁽¹⁰⁾ | 0 | 0 | 0 | 0 | 0 | 0 | 0 | 0 | 0 | 0 |
| Cross-linking agent ⁽¹¹⁾ | 2 | 2 | 2 | 2 | 2 | 2 | 2 | 2 | 2 | 2 |
| Crosslinking aid ⁽¹²⁾ | 1 | 1 | 1 | 1 | 1 | 1 | 1 | 1 | 1 | 1 |
| Stabilizer ⁽¹³⁾ | 5 | 5 | 5 | 5 | 5 | 5 | 5 | 5 | 5 | 5 |
| Antioxidant ⁽¹⁴⁾ | 0.3 | 0.3 | 0.3 | 0.3 | 0.3 | 0.3 | 0.3 | 0.3 | 0.3 | 0.3 |
| Antioxidant ⁽¹⁵⁾ | 1.5 | 1.5 | 1.5 | 1.5 | 1.5 | 1.5 | 1.5 | 1.5 | 1.5 | 1.5 |
| Softener ⁽¹⁶⁾ | 5 | 5 | 5 | 5 | 5 | 5 | 5 | 5 | 5 | 5 |
| Lubricant ⁽¹⁷⁾ | 1 | 1 | 1 | 1 | 1 | 1 | 1 | 1 | 1 | 1 |
| Lubricant ⁽¹⁸⁾ | 0.5 | 0.5 | 0.5 | 0.5 | 0.5 | 0.5 | 0.5 | 0.5 | 0.5 | 0.5 |
| Crosslinking | 0.5 | 0.5 | 0.5 | 0.5 | 0.5 | 0.5 | 0.5 | 0.5 | 0.5 | 0.5 |
| promoter ⁽¹⁹⁾ | | | | | | | | | | |

Evaluation items

| | | | | | | | | | | |
|---|---|---|---|---|---|---|---|---|---|---|
| Appearance after | ◯ | ◯ | ◯ | ◯ | ◯ | ◯ | ◯ | ◯ | ◯ | ◯ |
| extrusion (—) | | | | | | | | | | |
| Initial tension (MPa) | ◯(9.9) | ◯(6.2) | ◯(10.3) | ◯(6.4) | ◯(10.5) | ◯(6.5) | ◯(10.8) | ◯(6.7) | ◯(11.2) | ◯(7.0) |
| Initial elongation (%) | ◯(440) | ◯(400) | ◯(420) | ◯(390) | ◯(440) | ◯(400) | ◯(430) | ◯(380) | ◯(420) | ◯(360) |
| 200% modulus (MPa) | 3.0 | 5.0 | 3.1 | 5.2 | 3.2 | 5.5 | 3.2 | 5.6 | 3.4 | 5.9 |
| Strength after | ◯(98) | ◯(89) | ◯(97) | ◯(87) | ◯(98) | ◯(88) | ◯(99) | ◯(90) | ◯(102) | ◯(92) |
| aging (%) | | | | | | | | | | |
| Tension after | ◯(99) | ◯(87) | ◯(95) | ◯(88) | ◯(97) | ◯(85) | ◯(95) | ◯(91) | ◯(98) | ◯(91) |
| aging (%) | | | | | | | | | | |
| Insulation resistance | ◯(550) | ◯(530) | ◯(700) | ◯(650) | ◯(920) | ◯(780) | ◯(1040) | ◯(900) | ◯(1120) | ◯(980) |
| (MΩ · km) | | | | | | | | | | |
| Minimum thickness of | ◯(0.69) | ◯(0.74) | ◯(0.67) | ◯(0.73) | ◯(0.66) | ◯(0.75) | ◯(0.65) | ◯(0.74) | ◯(0.66) | ◯(0.70) |
| Insulation (mm) | | | | | | | | | | |
| (crushing properties | | | | | | | | | | |
| indicator) | | | | | | | | | | |

| Mixed components | Ex. 11 | Ex. 12 | Ex. 13 | Ex. 14 | Ex. 15 | Ex. 16 | Ex. 17 |
|---|---|---|---|---|---|---|---|
| Ethylene-propylene | 100 | 100 | 100 | 100 | 100 | 100 | 100 |
| copolymer ⁽¹⁾ | | | | | | | |
| Low-density | 0 | 0 | 0 | 0 | 0 | 0 | 0 |
| polyethylene ⁽²⁾ | | | | | | | |
| Talc 1 ⁽³⁾ | 0 | 0 | 0 | 0 | 0 | 0 | 0 |
| Talc 2 ⁽⁴⁾ | 0 | 0 | 0 | 0 | 0 | 0 | 0 |
| Talc 3 ⁽⁵⁾ | 0 | 0 | 0 | 0 | 0 | 0 | 0 |
| Talc 4 ⁽⁶⁾ | 0 | 0 | 0 | 0 | 0 | 0 | 0 |
| Talc 5 ⁽⁷⁾ | 0 | 0 | 0 | 0 | 0 | 0 | 0 |
| Talc 6 ⁽⁸⁾ | 100 | 250 | 250 | 250 | 250 | 250 | 250 |
| Talc 7 ⁽⁹⁾ | 0 | 0 | 0 | 0 | 0 | 0 | 0 |
| Talc 8 ⁽¹⁰⁾ | 0 | 0 | 0 | 0 | 0 | 0 | 0 |
| Cross-linking agent ⁽¹¹⁾ | 2 | 2 | 2 | 2 | 2 | 2 | 2 |
| Crosslinking aid ⁽¹²⁾ | 1 | 1 | 1 | 1 | 1 | 1 | 1 |
| Stabilizer ⁽¹³⁾ | 5 | 5 | 5 | 5 | 5 | 5 | 5 |
| Antioxidant ⁽¹⁴⁾ | 0.3 | 0.3 | 0.3 | 0.3 | 0.3 | 0.3 | 0.3 |
| Antioxidant ⁽¹⁵⁾ | 1.5 | 1.5 | 1.5 | 1.5 | 1.5 | 1.5 | 1.5 |
| Softener ⁽¹⁶⁾ | 5 | 5 | 5 | 5 | 5 | 5 | 5 |
| Lubricant ⁽¹⁷⁾ | 1 | 1 | 1 | 1 | 1 | 1 | 1 |
| Lubricant ⁽¹⁸⁾ | 0.5 | 0.5 | 0.5 | 0 | 0 | 2 | 0 |
| Crosslinking | 0.5 | 0.5 | 0 | 0.5 | 0 | 0 | 1 |
| promoter ⁽¹⁹⁾ | | | | | | | |

Evaluation items

| | | | | | | | |
|---|---|---|---|---|---|---|---|
| Appearance after | ◯ | ◯ | ◯ | ◯ | ◯ | ◯ | ◯ |
| extrusion (—) | | | | | | | |
| Initial tension (MPa) | ◯(11.6) | ◯(7.5) | ◯(8.1) | ◯(8.3) | ◯(8.4) | ◯(5.8) | ◯(5.5) |
| Initial elongation (%) | ◯(370) | ◯(360) | ◯(340) | ◯(330) | ◯(310) | ◯(380) | ◯(420) |
| 200% modulus (MPa) | 3.7 | 6.5 | 7.0 | 7.1 | 7.2 | 5.3 | 5.0 |
| Strength after | ◯(105) | ◯(94) | ◯(96) | ◯(93) | ◯(92) | ◯(93) | ◯(98) |
| aging (%) | | | | | | | |
| Tension after | ◯(94) | ◯(84) | ◯(86) | ◯(89) | ◯(89) | ◯(85) | ◯(82) |
| aging (%) | | | | | | | |
| Insulation resistance | ◯(1110) | (1010) | ◯(990) | ◯(1000) | ◯(1100) | ◯(880) | ◯(1080) |
| (MΩ · km) | | | | | | | |
| Minimum thickness of | ◯(0.67) | ◯(0.73) | ◯(0.71) | ◯(0.72) | ◯(0.73) | ◯(0.70) | ◯(0.69) |
| Insulation (mm) | | | | | | | |
| (crushing properties | | | | | | | |
| indicator) | | | | | | | |

| Mixed components | Ex. 18 | Ex. 19 | Ex. 20 | Ex. 21 | Ex. 22 | Ex. 23 |
|---|---|---|---|---|---|---|
| Ethylene-propylene | 100 | 100 | 50 | 50 | 50 | 50 |
| copolymer ⁽¹⁾ | | | | | | |
| Low-density | 0 | 0 | 50 | 50 | 50 | 50 |
| polyethylene ⁽²⁾ | | | | | | |
| Talc 1 ⁽³⁾ | 0 | 0 | 100 | 250 | 0 | 0 |
| Talc 2 ⁽⁴⁾ | 0 | 0 | 0 | 0 | 0 | 0 |
| Talc 3 ⁽⁵⁾ | 0 | 0 | 0 | 0 | 0 | 0 |
| Talc 4 ⁽⁶⁾ | 0 | 0 | 0 | 0 | 0 | 0 |
| Talc 5 ⁽⁷⁾ | 0 | 0 | 0 | 0 | 0 | 0 |
| Talc 6 ⁽⁸⁾ | 250 | 250 | 0 | 0 | 100 | 250 |
| Talc 7 ⁽⁹⁾ | 0 | 0 | 0 | 0 | 0 | 0 |
| Talc 8 ⁽¹⁰⁾ | 0 | 0 | 0 | 0 | 0 | 0 |
| Cross-linking agent ⁽¹¹⁾ | 2 | 2 | 2 | 2 | 2 | 2 |
| Crosslinking aid ⁽¹²⁾ | 1 | 1 | 1 | 1 | 1 | 1 |
| Stabilizer ⁽¹³⁾ | 5 | 5 | 5 | 5 | 5 | 5 |
| Antioxidant ⁽¹⁴⁾ | 0.3 | 0.3 | 0.3 | 0.3 | 0.3 | 0.3 |
| Antioxidant ⁽¹⁵⁾ | 1.5 | 1.5 | 1.5 | 1.5 | 1.5 | 1.5 |
| Softener ⁽¹⁶⁾ | 5 | 5 | 5 | 5 | 5 | 5 |
| Lubricant ⁽¹⁷⁾ | 1 | 1 | 1 | 1 | 1 | 1 |
| Lubricant ⁽¹⁸⁾ | 1 | 1 | 0.5 | 0.5 | 0.5 | 0.5 |
| Crosslinking | 1 | 0.5 | 0.5 | 0.5 | 0.5 | 0.5 |
| promoter ⁽¹⁹⁾ | | | | | | |

Evaluation items

| | | | | | | |
|---|---|---|---|---|---|---|
| Appearance after | ◯ | ◯ | ◯ | ◯ | ◯ | ◯ |
| extrusion (—) | | | | | | |
| Initial tension (MPa) | ◯(4.5) | ◯(6.9) | ◯(12.0) | ◯(8.2) | ◯(13.6) | ◯(9.5) |
| Initial elongation (%) | ◯(440) | ◯(390) | ◯(390) | ◯(350) | ◯(320) | ◯(310) |
| 200% modulus (MPa) | 4.1 | 4.1 | 4.2 | 7.2 | 5.0 | 8.0 |
| Strength after | ◯(98) | ◯(96) | ◯(99) | ◯(86) | ◯(100) | ◯(95) |
| aging (%) | | | | | | |
| Tension after | ◯(81) | ◯(83) | ◯(97) | ◯(84) | ◯(94) | ◯(82) |
| aging (%) | | | | | | |
| Insulation resistance | ◯(1030) | ◯(950) | ◯(580) | ◯(510) | ◯(1200) | ◯(990) |
| (MΩ · km) | | | | | | |
| Minimum thickness of | ◯(0.68) | ◯(0.69) | ◯(0.66) | ◯(0.70) | ◯(0.65) | ◯(0.70) |
| Insulation (mm) | | | | | | |
| (crushing properties | | | | | | |
| indicator) | | | | | | |

(Table 1 Remarks)
(0) Ex: Example
⁽¹⁾ Mooney viscosity (125° C., ML₁₊₄):23, ethylene content: 67 mass %, the third component: ethylidene-norbornene, the amount of the third component: 5.8 mass %
⁽²⁾ Low-density polyethylene (MFR: 3.5, Density: 0.918 g/cm³, Melting point: 108° C.)
⁽³⁾ Silicon to magnesium ratio = 0.9
⁽⁴⁾ Silicon to magnesium ratio = 1.1
⁽⁵⁾ Silicon to magnesium ratio = 1.3
⁽⁶⁾ Silicon to magnesium ratio = 1.5
⁽⁷⁾ Silicon to magnesium ratio = 1.6
⁽⁸⁾ Silicon to magnesium ratio = 1.8
⁽⁹⁾ Silicon to magnesium ratio = 0.8
⁽¹⁰⁾ Silicon to magnesium ratio = 2.0
⁽¹¹⁾ Dicumyl peroxide
⁽¹²⁾ Triallylisocyanurate
⁽¹³⁾ Zinc oxide
⁽¹⁴⁾ Poly(2,2,4-trimethyl-1,2-dihydroquinoline)
⁽¹⁵⁾ Mercaptobenzimidazole
⁽¹⁶⁾ Paraffin oil
⁽¹⁷⁾ Stearic acid
⁽¹⁸⁾ Bisoleic amide
⁽¹⁹⁾ Tetrakis(2-ethylhexyl) thiuram disulfid

TABLE 2

| | Comp | Comp | Comp | Comp | Comp | Comp | Comp | Comp | Comp | Comp |
|---|---|---|---|---|---|---|---|---|---|---|
| Mixed components | Ex. 1 | Ex. 2 | Ex. 3 | Ex. 4 | Ex. 5 | Ex. 6 | Ex. 7 | Ex. 8 | Ex. 9 | Ex. 10 |
| Ethylene-propylene | 100 | 100 | 100 | 100 | 100 | 100 | 100 | 100 | 100 | 100 |
| copolymer ⁽¹⁾ | | | | | | | | | | |
| Low-density | 0 | 0 | 0 | 0 | 0 | 0 | 0 | 0 | 0 | 0 |
| polyethylene ⁽²⁾ | | | | | | | | | | |
| Talc 1 ⁽³⁾ | 50 | 300 | 0 | 0 | 0 | 0 | 0 | 0 | 0 | 0 |
| Talc 2 ⁽⁴⁾ | 0 | 0 | 0 | 0 | 0 | 0 | 0 | 0 | 0 | 0 |
| Talc 3 ⁽⁵⁾ | 0 | 0 | 0 | 0 | 0 | 0 | 0 | 0 | 0 | 0 |
| Talc 4 ⁽⁶⁾ | 0 | 0 | 0 | 0 | 0 | 0 | 0 | 0 | 0 | 0 |
| Talc 5 ⁽⁷⁾ | 0 | 0 | 0 | 0 | 0 | 0 | 0 | 0 | 0 | 0 |
| Talc 6 ⁽⁸⁾ | 0 | 0 | 0 | 0 | 0 | 0 | 0 | 0 | 0 | 0 |
| Talc 7 ⁽⁹⁾ | 0 | 0 | 100 | 250 | 0 | 0 | 0 | 0 | 0 | 0 |
| Talc 8 ⁽¹⁰⁾ | 0 | 0 | 0 | 0 | 100 | 250 | 100 | 100 | 100 | 100 |
| Cross-linking agent ⁽¹¹⁾ | 2 | 2 | 2 | 2 | 2 | 2 | 2 | 2 | 2 | 2 |
| Crosslinking aid ⁽¹²⁾ | 1 | 1 | 1 | 1 | 1 | 1 | 1 | 1 | 1 | 1 |
| Stabilizer ⁽¹³⁾ | 5 | 5 | 5 | 5 | 5 | 5 | 5 | 5 | 5 | 5 |
| Antioxidant ⁽¹⁴⁾ | 0.3 | 0.3 | 0.3 | 0.3 | 0.3 | 0.3 | 0.3 | 0.3 | 0.3 | 0.3 |
| Antioxidant ⁽¹⁵⁾ | 1.5 | 1.5 | 1.5 | 1.5 | 1.5 | 1.5 | 1.5 | 1.5 | 1.5 | 1.5 |
| Softener ⁽¹⁶⁾ | 5 | 5 | 5 | 5 | 5 | 5 | 5 | 5 | 5 | 5 |
| Lubricant ⁽¹⁷⁾ | 1 | 1 | 1 | 1 | 1 | 1 | 1 | 1 | 1 | 1 |
| Lubricant ⁽¹⁸⁾ | 0.5 | 0.5 | 0.5 | 0.5 | 0.5 | 0.5 | 0.5 | 0 | 2 | 0 |
| Crosslinking promoter ⁽¹⁹⁾ | 0.5 | 0.5 | 0.5 | 0.5 | 0.5 | 0.5 | 0 | 0 | 0 | 1 |

Evaluation items

| | | | | | | | | | | |
|---|---|---|---|---|---|---|---|---|---|---|
| Appearance after | ◯ | ◯ | ◯ | ◯ | X | X | X | X | X | X |
| extrusion (—) | | | | | | | | | | |
| Initial tension (MPa) | ◯(11.0) | ◯(5.5) | ◯(9.9) | ◯(6.4) | ◯(12.0) | ◯(7.5) | ◯(12.8) | ◯(13.1) | ◯(9.9) | ◯(10.1) |
| Initial elongation (%) | ◯(500) | X(120) | ◯(460) | ◯(400) | ◯(370) | ◯(370) | ◯(380) | ◯(360) | ◯(430) | ◯(430) |
| 200% modulus (MPa) | 2.5 | — | 2.9 | 5.2 | 4.0 | 6.8 | 4.5 | 4.9 | 3.8 | 3.7 |
| Strength after | ◯(99) | ◯(89) | ◯(97) | ◯(87) | ◯(101) | ◯(92) | ◯(103) | ◯(101) | ◯(103) | ◯(101) |
| aging (%) | | | | | | | | | | |
| Tension after | ◯(99) | ◯(87) | ◯(95) | ◯(88) | ◯(98) | ◯(88) | ◯(98) | ◯(100) | ◯(92) | ◯(90) |
| aging (%) | | | | | | | | | | |
| Insulation resistance | ◯(570) | ◯(510) | X(490) | X(430) | ◯(1120) | ◯(1030) | ◯(1100) | ◯(1210) | ◯(990) | ◯(1180) |
| (MΩ · km) | | | | | | | | | | |
| Minimum thickness of | X(0.57) | ◯(0.74) | ◯(0.67) | ◯(0.73) | ◯(0.67) | ◯(0.72) | ◯(0.68) | ◯(0.69) | ◯(0.65) | ◯(0.65) |
| Insulation (mm) | | | | | | | | | | |
| (Indicator of | | | | | | | | | | |
| crushing properties) | | | | | | | | | | |

(Table 2 Remarks)
(0) CompEx: Comparative Example
⁽¹⁾ Mooney viscosity (125° C., ML₁₊₄):23, ethylene content: 67 mass %, the third component: ethylidene-norbornene, the amount of the third component: 5.8 mass %
⁽²⁾ Low-density polyethylene (MFR: 3.5, Density: 0.918 g/cm³, Melting point: 108° C.)
⁽³⁾ Silicon to magnesium ratio = 0.9
⁽⁴⁾ Silicon to magnesium ratio = 1.1
⁽⁵⁾ Silicon to magnesium ratio = 1.3
⁽⁶⁾ Silicon to magnesium ratio = 1.5
⁽⁷⁾ Silicon to magnesium ratio = 1.6
⁽⁸⁾ Silicon to magnesium ratio = 1.8
⁽⁹⁾ Silicon to magnesium ratio = 0.8
⁽¹⁰⁾ Silicon to magnesium ratio = 2.0
⁽¹¹⁾ Dicumyl peroxide
⁽¹²⁾ Triallylisocyanurate
⁽¹³⁾ Zinc oxide
⁽¹⁴⁾ Poly(2,2,4-trimethyl-l,2-dihydroquinoline)
⁽¹⁵⁾ Mercaptobenzimidazole
⁽¹⁶⁾ Paraffin oil
⁽¹⁷⁾ Stearic acid
⁽¹⁸⁾ Bisoleic amide
⁽¹⁹⁾ Tetrakis(2-ethylhexyl) thiuram disulfid

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. An elastomer composition, comprising:
a base polymer including not less than 50 mass % of ethylene-α-olefin copolymer; and
a talc that has a mass ratio of silicon to magnesium (Si/Mg) of 0.9 to 1.8 and is mixed in an amount of 100 to 250 parts by mass per 100 parts by mass of the ethylene-α-olefin copolymer.

2. The elastomer composition according to claim 1, further comprising:
an amide-based lubricant mixed in an amount of 0.1 to 2 parts by mass per 100 parts by mass of the ethylene-α-olefin copolymer; and
a thiuram-based vulcanization retarder mixed in an amount of 0.1 to 1 part by mass per 100 parts by mass of the ethylene-α-olefin copolymer,
wherein the mixed amount in total of the amide-based lubricant and the thiuram-based vulcanization retarder is not more than 2 parts by mass per 100 parts by mass of the ethylene-α-olefin copolymer.

3. An insulated wire, comprising:
a conductor; and
an insulation layer covering an outer periphery of the conductor,
wherein the insulation layer comprises the elastomer composition according to claim 1 and being crosslinked.

4. An insulated cable, comprising:
at least one insulated wire comprising a conductor and an insulation layer; and
a sheath covering an outer periphery of the at least one insulated wire,
wherein the sheath comprises the elastomer composition according to claim 1 and being crosslinked.
